(19) United States
(12) Patent Application Publication
(10) Pub. No.: US 2020/0252763 A1
(43) Pub. Date: Aug. 6, 2020

(54) Differentiated Abatement of Charging Requests in Case of Overload at Online Charging System

(71) Applicant: Telefonaktiebolaget LM Ericsson (publ), Stockholm (SE)

(72) Inventor: Robert TÖRNKVIST, Karlskrona (SE)

(21) Appl. No.: 16/651,026

(22) PCT Filed: Dec. 22, 2017
(86) PCT No.: PCT/EP2017/084397

§ 371 Date: Mar. 26, 2020

Related U.S. Application Data
(60) Provisional application No. 62/569,052, filed on Oct. 6, 2017.

(51) Int. Cl. H04W 4/24; H04M 15/00; H04W 24/04

(52) U.S. Cl. CPC H04W 4/24; H04M 2215/32; H04W 24/04; H04M 15/64

(57) ABSTRACT

It is recognized herein that certain ones of the requests subject to abatement, otherwise referred to as overload control, have more “value” (monetary or otherwise) than other ones of the requests. The relative importance of requests may be advantageously considered when deciding which requests are discarded or deferred for alleviation of an overload situation at the OCS. Further, it is also recognized herein that certain ones of the requests may be more sensitive or less sensitive to processing delays, meaning that certain requests are more amenable to buffering-based abatement than others. The methods and apparatuses disclosed herein provide, among other things, mechanisms by which an OCS configures the overload controls imposed at CTFs or other requesting entities in a communication network, meaning that the OCS can prioritize which requests are sent to it during overload conditions, at least in terms of the underlying services or circumstances associated with the request.

### TECHNICAL FIELD

The present solution relates to methods, systems, a computer program and a computer program product for overload control of charging signaling in a communication network.

### BACKGROUND

Online Charging Systems, OCSs, provide real time credit authorization, for a requested usage of network resources. With OCS-based charging mechanisms, the use of network resources associated with a user starting or continuing usage of a communication service provided via a communication network require real time credit authorization, to avoid allowing usage of network resources beyond that permitted by the available credit. For examples of online charging system details, see TS 32.299 V14.5.0 (2017-09), as promulgated by the 3rd Generation Partnership Project, 3GPP TS 32.299 details charging applications based on the DIAMETER protocol, which is also specified in IETF RFC 6733.

In an example scenario, Charging Trigger Functions, CTFs, or other entities within a communication network send charging requests to an OCS, requesting authorization for usage of communication network resources, in association with establishing or continuing communication sessions used to provide users with various communication services. For each request, the OCS determines whether sufficient credit is available, and it returns a corresponding response, authorizing or denying the request.

Because of the increasing number of users and range of premium services requiring online charging control, the various entities involved in online charging face increasing operating loads, where, for example, “load” may be expressed in terms of CPU load. The 3GPP has explored solutions for overload handling for charging as described in 3GPP TR 32.869 V0.6.0 (2017-08) and IETF RFC 7683. These documents explain that an overloaded node may convey to a requesting node how much the requesting node should decrease its traffic to the overloaded node, and the requesting node effects the reduction by randomly discarding or buffering requests that it would have otherwise sent to OCS. Such operations do not account for the complexities associated with real time charging in current and future networks.

### SUMMARY

In the context of Online Charging Systems, OCSs, Charging Trigger Functions, CTFs, or other requesting entities in a communication network send charging requests to the OCS, for authorization of access to communication network resources by users of the communication network. The OCS becomes overloaded if the number of requests incoming to it within a given interval exceeds its processing capabilities. While current practices provide for overload control, wherein the OCS indicates to one or more of the requesting entities that they should reduce the number of requests being sent to the OCS, existing practices do not provide for request prioritization or discrimination at the requesting nodes. That is, the imposition of overload control at the requesting nodes abates the rate at which the requesting node sends charging requests to the OCS by suppressing a certain number or percentage of requests on a random basis, without discriminating between the communication services or other circumstances associated with those requests.

It is recognized herein that certain ones of the requests subject to abatement, otherwise referred to as overload control, have more “value” (monetary or otherwise) than other ones of the requests, and that the relative importance of requests may be advantageously considered when deciding which requests are discarded or deferred for the alleviation of the overload situation at the OCS. Further, it is also recognized herein that certain ones of the requests may be more sensitive or less sensitive to processing delays, meaning that certain requests are more amenable to buffering-based abatement than others. The methods and apparatuses disclosed herein provide, among other things, mechanisms by which an OCS configures the overload controls imposed at CTFs or other requesting entities in a communication network, meaning that the OCS can prioritize which requests are sent to it during overload conditions, at least in terms of the underlying services or circumstances associated with the request.

It is an object to provide a method, an Online Charging System, a computer program and a computer program product for overload control of charging signaling in a communication network, to alleviate at least some of the disadvantages set out above.

A further object is to provide a method and apparatus for controlling charging of a service in a communication network mitigating the increased signaling and load on the communication network when the number of requests in a given time interval—i.e., the rate of requests—increases due to higher demands on accuracy, more frequent users and/or increasing number of services, which are often used in parallel.

In an example embodiment, a processing apparatus performs a method of overload control in an Online Charging System, OCS, associated with a communication network. The method includes determining configuration information dynamically as a function of load arising at the OCS from ongoing reception and processing of charging requests sent from one or more Charging Trigger Functions, CTFs, in the communication network. This workload may, for example, be expressed in term of CPU load. In any case, in this context, each given charging request is associated with at least one of a service identifier, a rating group, and an interrogation type, which associated parameter or parameters may not be carried in the request itself, but are otherwise known or discoverable by the OCS.

Advantageously, the configuration information configures one or more abatement treatments to be applied by at least one of the one or more CTFs, for abating the rate at which the at least one CTF sends charging requests to the OCS. Correspondingly, in carrying out the method, the processing apparatus determines the configuration information according to a defined prioritization scheme. The prioritization scheme determines which charging requests are subject to which abatement treatment, as a function of one or more of service identifier, rating group, and interrogation type. The method further includes sending the configuration information to the at least one CTF. Here, referring to “the at least one CTF” does not preclude sending configuration information to all CTFs that communicate with the OCS, but it recognizes that not all CTFs necessarily support the contemplated abatement configuration. Further, on that point, it shall be understood that the OCS may tailor the configuration information sent to individual CTFs, for example, based on the overload control features—abatement treatments—supported by the CTF.

In another example embodiments, a processing apparatus is configured to perform overload control for an OSC associated with a communication network. The processing apparatus is operative as an Online Charging Function, OCF, in the OCS and comprises interface circuitry and processing circuitry. The interface circuitry is configured for communicating with one or more CTFs in the communication network, and the processing circuitry is operatively associated with the interface circuitry and configured for overload control.

In at least one example of being configured for overload control, the processing circuitry is configured to determine configuration information dynamically as a function of load arising at the OCS from ongoing reception and processing of charging requests sent from the one or more CTFs. Each given charging request has one or more of an associated service identifier, an associated rating group, and an associated interrogation type, and the configuration information configures one or more abatement treatments to be applied by at least one of the one or more CTFs, for abating the rate at which the at least one CTF sends charging requests to the OCS. The configuration information is determined by the processing apparatus according to a defined prioritization scheme that determines which charging requests are subject to which abatement treatment, as a function of one or more of service identifiers, rating groups, and interrogation types. The processing circuitry is further configured to send the configuration information to the at least one CTF, e.g., as a charging request response sent via the interface circuitry.

In another example embodiment, a CTF or other charging entity in a communication network carries out a method of overload control for an OCS associated with the communication network. The method includes receiving configuration information from the OCS and controlling abatement of the rate at which the CTF sends charging requests to the OCS, according to the configuration information. Each given charging request has one or more of an associated service identifier, an associated rating group, and an associated interrogation type. Correspondingly, the configuration information configures one or more abatement treatments that are applied by the CTF. Particularly, the configuration information indicates which charging requests are subject to which abatement treatment, as a function of at least one of service identifiers, rating groups, and interrogation types. As such, the CTF differentiates its abatement of charging requests by controlling whether or to what extent a configured abatement treatment is applicable to given charging requests, in dependence on at least one of the following: the service identifier or identifiers associated with the given charging requests, the rating group or groups associated with the given charging requests, and the interrogation type or types associated with the given charging requests.

In another example embodiment, a processing apparatus is configured for overload control for an OCS associated with a communication network. The processing apparatus is operative as a CTF in the communication network, and includes interface circuitry and processing circuitry.

The interface circuitry is configured for communicating with the OCS, and the processing circuitry is operatively associated with the interface circuitry and configured to carry out overload control operations. In at least one such embodiment, the processing circuitry is configured to receive configuration information from the OCS, and control abatement of the rate at which the CTF sends charging requests to the OCS, according to the configuration information. Each given charging request has one or more of an associated service identifier, an associated rating group, and an associated interrogation type. Correspondingly, the configuration information configures one or more abatement treatments that are applied by the CTF, including indicating which charging requests are subject to which abatement treatment, as a function of at least one of service identifiers, rating groups, and interrogation types.

### BRIEF DESCRIPTION OF THE DRAWINGS

FIG. 1 is a block diagram of one embodiment of an Online Charging System, OCS, and one or more Charging Trigger Functions, CTFs, that are configured according to the teachings herein.

FIG. 2 is a block diagram of example embodiments of an OCS and a CTF, such as may be implemented in the OCS and CTFs introduced in FIG. 1.

FIGS. 3 and 4 are logic flow diagrams of example embodiments of methods of overload control, as respectively carried out at an OCS and a CTF, respectively.

FIG. 5 is a message sequence diagram showing example signaling according to one embodiment of overload control processing contemplated herein.

FIG. 6 is a message sequence diagram showing example signaling according to another embodiment of overload control processing contemplated herein.

FIG. 7 is a block diagram showing further example details for an OCS, according to one or more embodiments.

FIG. 8 is a block diagram showing one embodiment of a computer program product, comprising a non-transitory computer readable medium and a computer program stored on the computer readable medium, wherein the computer program product configures an OCS and/or a CTF according to an embodiment of the overload control teachings disclosed herein.

### DETAILED DESCRIPTION

The methods and apparatus illustrated by way of the examples presented in this document provide for a load reduction mechanism that discriminates whether or to what extent load reduction, i.e., abatement, applies to given charging requests, in dependence on the communication services associated with the charging requests and/or in dependence on the states of the communication sessions associated with the charging requests. Such differentiation offers numerous advantages, not least because it provides for the discriminatory application of abatement treatments, reflecting the fact that different ones of the charging requests that are potential candidates for abatement treatment may be more valuable or less valuable than others.

By way of example, various charging requests correspond to different communication services or types of services, one or more of which may be prioritized. The communication service or service type associated with a given charging request may be gleaned from the service identifier of the involved service, e.g., video streaming, music streaming, web browsing, download, etc. Correspondingly, in any given interval, a Charging Trigger Function, CTF, determines whether or to what extent to apply one or more configured abatement treatments, e.g., a 10% reduction via discarding or buffering, to given charging requests to be sent to an Online Charging System, OCS, based on determining which ones of the requests have a service identifier or identifiers specified in configuration information received from the OCS.

Additionally, or alternatively, similar discriminatory application of abatement treatments may be based on rating groups (charging rates) and/or interrogation types. In this regard, an interrogation type associated with a charging request indicates whether the request is an initial request for a communication session to be established, an intermediate request for continuing an established communication session, or a final request, for closing an established communication session. As such, interrogation type represents the “state” of the communication session involved with the request, and one or more abatement treatments contemplated herein differentiate abatement based on the session states associated with charging requests, e.g., as gleaned from interrogation type information.

In at least one embodiment, the OCS and CTF or CTFs involved in the overload control use the DIAMETER protocol for credit control operations, as defined in IETF RFC 4006. The DIAMETER protocol defines the following Information Elements (IEs) or attributes: Service Identifier, Rating Group, and Interrogation Type. In at least one embodiment contemplated herein, one or more of the foregoing IEs or attributes are used to determine the applicability of a defined abatement treatment to given charging requests. For example, the OCS may specify that a given abatement treatment applies only to charging requests associated with a specified Service Identifier, or a specified Rating Group, or a specified Interrogation Type. The applicability may be an overall applicability that defines whether the abatement treatment applies at all, or the applicability may be defined in terms of the extent of abatement that applies to charging requests associated with a specified Service Identifier, Rating Group, and/or Interrogation Type.

Assume, for example, that the abatement treatment is a “discard” treatment wherein the CTF applying the treatment discards one or more of the charging requests that it otherwise would have sent to the OCS during a given interval. The configuration information received by the CTF from the OCS may identify charging requests that are to be excluded from, or included in the abatement treatment, e.g., by specifying certain Service Identifiers and/or Rating Groups and/or Interrogation Types. In at least one embodiment, the configuration information from the OCS specifies the extent to which the treatment applies to given charging requests as a function of their associated Service Identifiers and/or Rating Groups and/or Interrogation Types. For example, charging requests associated with a first Service Identifier are subject to a 10% abatement, where 10% of them are discarded rather than sent to the OCS, while charging requests associated with a second Service Identifier are subject to a 90% abatement. Additional or alternative differentiations of the same sort may be based on Rating Group and/or Interrogation Type.

Among other things, configuring the abatement treatment(s) in this manner allows overload control to discriminate based on the communication services involved, e.g., as between high speed data, music streaming, social media voice, etc. Specific distinctions can be made for specific services, e.g., for SPOTIFY. In another example, the OCS configures an abatement treatment that applies more aggressive abatement to charging requests that are associated with initial interrogations, as they correspond to the establishment of new communication sessions. Charging requests that are associated with intermediate or final interrogations may be excluded from abatement altogether, or may be subjected to less aggressive abatement, e.g., charging requests associated with initial interrogations are subject to a 90% abatement, whereas charging requests associated with intermediate or final interrogations are subject to a 10% abatement.

In another example, an abatement algorithm or treatment may indicate a 100% reduction for charging requests associated with social media service identifiers or rating groups, while indicating only a 50% reduction for charging requests associated with NETFLIX video streaming. Additionally, or alternatively, the abatement algorithm may indicate a 100% reduction of initial charging requests, at least for one or more specified rating groups, while indicating only a 60% reduction for intermediate charging requests. Here, initial charging requests shall be understood as involving session starts, while intermediate charging requests involve ongoing sessions. As such, during overload conditions, or to avoid reaching overload conditions, the OCS may configure the suppression of charging requests associated with establishing new sessions more aggressively than charging requests associated with established, ongoing sessions.

The above example operations bring the advantage of making the barring or buffering of charging requests more selective and charging requests with a lower value—regardless of how “value” is assessed or measured for defining the priority scheme—will be the first to be barred or buffered before requests with higher values are barred or buffered. This selectivity results in lower mean revenue loss for the network operator in overload situations.

Embodiments of contemplated example implementations will now be described in more detail and with references to the accompanying drawings.

In the following description, for purposes of explanation and non-limitation, specific details are set forth, such as particular nodes, functional entities, techniques, protocols, standards, etc., to provide an understanding of the described technology. It will be apparent to one skilled in the art that other embodiments may be practiced apart from the specific details disclosed below. In other instances, detailed descriptions of well-known methods, devices, techniques, etc., are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general-purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like, represent various processes which may be substantially represented in a non-transitory computer readable medium and so executed by a computer or other processor, whether such computer or other processor is explicitly shown.

The functions of the various elements including functional blocks, including but not limited to those labeled or described as “computer”, “processor” or “controller” may be provided through the use of fixed processing circuitry and/or through the use of processing circuitry that is configured by executing software in the form of coded instructions stored on computer readable medium. Thus, such functions and illustrated functional blocks are to be understood as being implemented via fixed, preconfigured circuitry, or via programmatically configured circuitry, or via some mix of both fixed and programmatically configured circuitry.

In terms of hardware implementation, the functional blocks may include or encompass, without limitation, digital signal processor (DSP) hardware, reduced instruction set processors, or other digital or analog circuitry, including but not limited to application specific integrated circuit(s) (ASIC) and/or state machines capable of performing such functions.

In terms of computer implementation, a computer is generally understood to comprise one or more processors, or one or more controllers, and the terms computer and processor and controller may be employed interchangeably herein. When provided by a computer, processor, or controller, the functions may be provided by a single dedicated computer, processor, or controller, by a single shared computer, processor, or controller, or by a plurality of individual computers, processors, or controllers, some of which may be shared or distributed. Moreover, use of the term “processor” or “controller” shall also be construed to refer to other hardware capable of performing such functions and/or executing software, such as the example hardware recited above.

The technology associated with a “communication network” as that term is used herein may involve, for example, any type of cellular radio communications, such as GSM, CDMA, 3G, 4G, etc. For ease of description, the term user equipment or UE encompasses any kind of radio communications apparatus configured for operation in the involved communication network, such as a terminal/device, mobile station (MS), PDAs, cell phone, laptop, etc.

Referring now more particularly to the drawings in which like reference numerals indicate like parts throughout the several views.

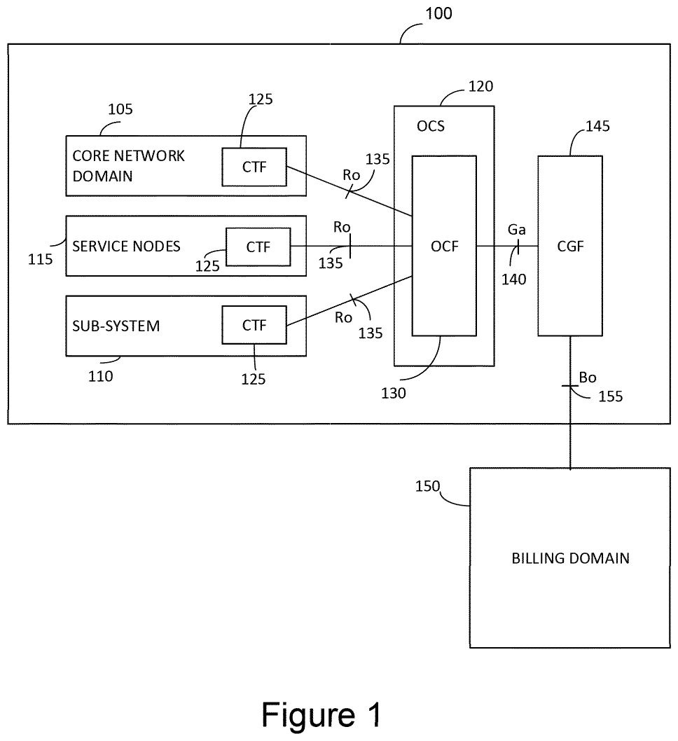

FIG. 1 is a block diagram showing an example communication network and associated online charging architecture, according to an example embodiment.

A communication network 100 includes a core network 105, e.g., an Evolved Packet Core or EPC, a subsystem 110, e.g., an IP Multimedia Subsystem or IMS, and any number of “service” nodes 115. Any number of communication services may be provided by or through the communication network 100, e.g., messaging services provided by a Multimedia Messaging System or MMS, voice services, streaming services, social media, web surfing, etc. To support charging mechanisms associated with providing such services, the network 100 performs real-time monitoring of required network resource usage to detect the relevant chargeable events.

The various computer servers or other entities in the network 100 involved in such chargeable events include Charging Trigger Functions, CTFs 125, which are configured to interface with an Online Charging System, OCS 120. When network resources are requested in conjunction with a chargeable event, e.g., establishing or continuing a multimedia streaming service carried over the network 100, one or more CTFs 125 send charging requests towards the OCS 120. In turn, the OCS 120 generates return responses, indicating whether or to what extent resource usage is authorized. The OCS 120 makes such decisions based on determining whether or to what extent the applicable subscriber account has available credit.

In the illustrated example, the OCS 120 includes a processing apparatus configured for operation as an Online Charging Function, OCF 130, that is operative to process incoming charging requests. In a DIAMETER-based embodiment, the charging requests and associated return responses may be exchanged over a standardized “Ro” interface 135. In such contexts, the charging requests are Credit Control Requests or CCRs that are configured according to the DIAMETER protocol, and the corresponding charging request responses are Credit Control Answers or CCAs, also configured according to the DIAMETER protocol.

As seen in the diagram, and in keeping with a non-limiting DIAMETER-based example, the OCF 130 may also interact with a Charging Gateway Function, CGF 145, via a standardized “Ga” interface 140. In turn, the CGF 145 communicates with a billing domain computer system 150, via a standardized “Bo” interface 155.

Typical examples of network resource usage requests involve, for example, a voice call of certain duration, the transport of a certain volume of data, or the submission of a multimedia message of a certain size. The network resource usage requests may be initiated by a User Equipment UE or by the network 100. In either case, the OCS 120 is configured to provide real time charging control by processing the charging requests incoming from the CTFs 125, in association with requested resource usages. Correspondingly, the CTFs 125 generate the charging requests by assembling charging information relevant to the requested network resource usage, and sending such information in the form of charging requests towards the OCF 130. The charging request responses correspondingly returned to the requesting CTFs 125 may provide for limited authorization, e.g., limited quotas expressed in terms of volume of data, or limited durations of network resource usage.

Thus, any given communication session may involve multiple requests and authorization, e.g., to establish the session and then to continue the session. Consequently, the volume of charging requests incoming to the OCS 120 during times of high network usage may be substantial, and, at times, may be enough to overload the OCS 120. In the methods and apparatuses contemplated herein, for respective use at the OCS 120 and at least one CTF 125, the rate—also referred to as the “pace”—of charging requests incoming to the OCS 120 is reduced via the prioritized application of one or more abatement treatments at the at least one CTF 125. Each CTF 125 may have an OCF address list, identifying the OCF 130 or OCFs 130 to which it can send its charging events and/or charging requests.

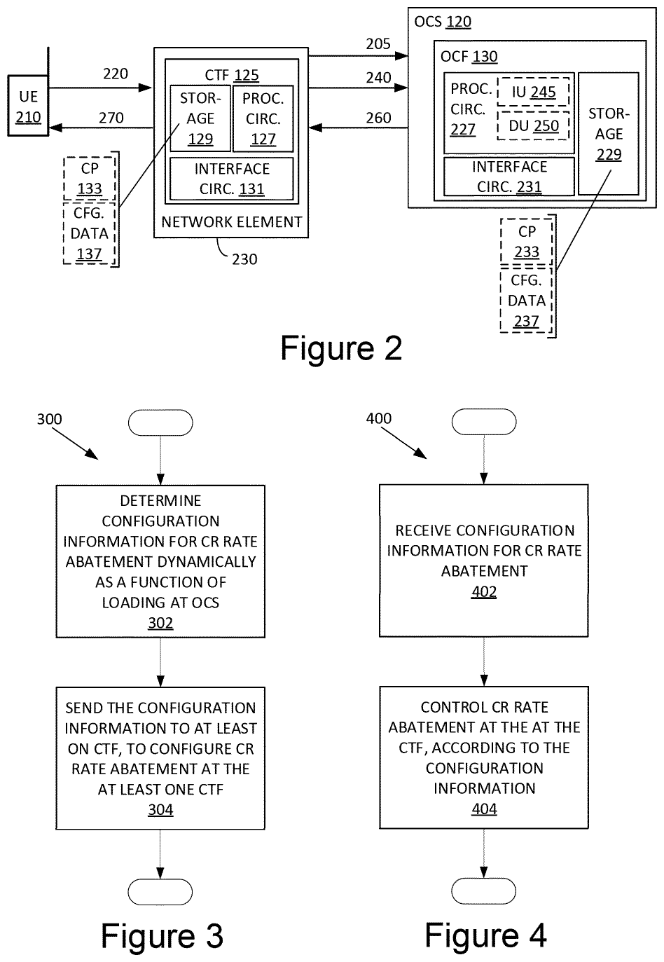

FIG. 2 is a block diagram illustrating example details for a CTF 125 and an OCS 120, according to one or more embodiments contemplated herein.

The example CTF 125 includes processing circuitry 127, storage 129, comprising one or more types of computer-readable media, and interface circuitry 131. In an example implementation, the CTF 125 comprises a processing apparatus included in or operative as a network element 230 that is configured for operation in the communication network 100.

The processing circuitry 127 comprises fixed circuitry or programmatically configured circuitry, or some combination of both. In at least one embodiment, the processing circuitry 127 is specially adapted to operate according to the examples described herein, based on the execution of stored computer program instructions included in one or more computer programs 133, which may be stored in the storage 129. In that regard, the processing circuitry 127 may comprise one or more microprocessors, microcontrollers, digital signal processors, FPGAs, ASICs, or other digital processing circuitry. The storage 129 may also store one or more items of configuration data 137, such as configuration information that controls the abatement treatment or treatments that are selectively applied by the CTF 125, to reduce load at the OCS 120.

The example OCS 120 includes a processing apparatus operative as an OCF 130. The OCF 130 includes processing circuitry 227, storage 229, and interface circuitry 231. The processing circuitry 227 comprises fixed circuitry or programmatically configured circuitry, or some combination of both. In at least one embodiment, the processing circuitry 227 is specially adapted to operate according to the examples described herein, based on the execution of stored computer program instructions included in one or more computer programs 233, which may be stored in the storage 229. In that regard, the processing circuitry 227 may comprise one or more microprocessors, microcontrollers, digital signal processors, FPGAs, ASICs, or other digital processing circuitry. The storage 229 may also store one or more items of configuration data 237, such as configuration information that controls the abatement treatment or treatments that are selectively applied by the CTF 125, to reduce load at the OCS 120.

Before a user—represented here as a User Equipment or UE 210—has started a communication session associated with a communication service, the involved CTF 125 may send its supported overload control features via signaling 205 to the OCS 120. By sending this feature information to the OCS 120, the CTF 125 enables the OCS 120 to determine what overload control features are supported by the CTF 125. In other words, the feature information sent from the CTF 125 to the OCS 120 in the signaling 205 tells the OCS 120 what abatement treatment configurations are supported by the CTF 125. In an example of the feature information conveyed in the signaling 205, the CTF 125 indicates its support for differentiating its abatement treatment of charging requests as a function of one or more of the following: service identifiers associated with the charging requests, rating groups associated with charging requests, and session states associated with the charging requests.

In this context, it will be appreciated that a given charging request to be sent from the CTF 125 to the OCS 120 corresponds to a request for network resources, for a communication service being provided or to be provided to a user of the communication network 100. In the diagram, the signaling 240 represents one or more charging requests going from the CTF 125 to the OCS 120, and the signaling 260 represents the one or more corresponding charging request responses from the OCS 120 to the CTF 125. A given charging request requests, for example, some specified number of units of service usage. In other instances, the charging request may not specify the number of service units requested. In either case, a corresponding charging request response from the OCS 120 may specify the service usage quota authorized for the involved session.

The requested service—see signaling 270—will be delivered to the UE 210 under surveillance of the CTF 125, ensuring that the service usage quota indicated by the OCS 120 is not exceeded. The CTF 125 also may impose or adapt one or more abatement treatments based on selected values included in configuration information returned by the OCS 120, e.g., as part of the signaling 260. The abatement treatment or treatments reduce the number of charging requests sent by the CTF 125 towards the OCS 120 in a given interval, e.g., by discarding or buffering some percentage of requests that would have otherwise been sent to the OCS 120 during the interval. However, “abatement” as contemplated herein does not treat all requests equally, and, instead, prioritizes or penalizes some requests over others, as a function of one or more of service identifier, rating group, and interrogation type. Given charging requests normally are associated with at least one of an associated service identifier, an associated rating group, and an associated interrogation type. The service identifier and/or rating group depend upon the involved communication service, while the interrogation type depends upon the state of the involved session—e.g., new, ongoing, or closing.

In the case of abatement by buffering, the CTF 125 may hold the buffered requests until the overload situation ends at the OCS 120, which may be indicated in signaling from the OCS 120, e.g., by sending updated configuration information that specifies no abatement, or by sending an explicit indication of no overload. When the overload ends, the CTF 125 sends the buffered charging requests to the OCS 120 in the order they were buffered, possibly with an indication that they were buffered, for further processing.

More broadly, in at least some embodiments, the OCS 120 includes configuration information in one or more of the charging requests responses it returns to the CTF 125, to configure one or more abatement treatments at the CTF 125. Although such information may be returned in a session-specific charging request response, the configuration information itself is not specific to the session in which it is provided. Similarly, the CTF 125 may send its feature information—i.e., information indicating the abatement treatments it supports—in one or more charging requests sent to the OCS 120, for a given session or sessions. Although sent in session-specific messaging, the feature information is not session specific.

Notably, this scheme allows the feature information to flow from the CTF 125 to the OCS 120, and the abatement configuration information to flow from the OCS 120 to the CTF 125, using ongoing charging request and response signaling. Notably, the scheme does not require that all charging requests carry feature information to the OCS 120, nor does it require all charging request responses to carry configuration information back to the CTF 125. Indeed, in at least one embodiment, the OCS 120 may not send configuration information to the CTF 125 except when it wishes to establish an initial configuration at the CTF 125, or to update the current configuration, e.g., in view of a changing load situation at the OCS 120. Broadly, the OCS 120 may send updated configuration information whenever it wants to reconfigure overload controls at the CTF 125. In this context, the OCS 120 may configure the CTF 125 for no abatement, and later update that configuration to avoid or relieve an overload situation at the OCS 120.

In one example scenario the network element 230 is a Gateway GPRS Support Node GGSN. During a high-profile football game or other public event, the GGSN may reach or at least approach its capacity peak. For example, there may be many UEs 210 requesting or engaged in Internet Protocol Television, IP-TV, data sessions, thus causing extensive network signaling. In this scenario, the OCS 120 may detect a system load of, say 95%. According to the teachings herein, in such a scenario, the OCS 120 determines configuration information for prioritized abatement of the charging requests being sent from the CTF 125, and it sends the configuration information to the CTF 125, to initiate imposition of accordingly configured abatement treatments at the CTF 125. The OCS 120 may signal the same or other configurations to other CTFs 125, and it may tailor the particular configurations sent to particular CTFs 125, based on having received information from them regarding the abatement treatments they support.

For example, the configuration information may specify abatement or no abatement, or an extent of abatement to be applied to charging requests in dependence on one or more of service identifiers, rating groups, and interrogation types. The CTF 125 imposes the corresponding abatement treatment, also referred to as a “loss algorithm”, according to the configuration information received from the OCS 120. For example, the OCS 120 may configure an overall reduction in the number of charging requests sent from the CTF 125 in a given interval, based on its current load situation. The OCS 120 may further use the configuration information to specify which charging requests are subject to the abatement treatment by specifying with which service identifiers and/or rating groups and/or interrogation types the abatement treatment is associated. The CTF 125 then applies the abatement treatment to charging requests that are associated with the specified service identifiers and/or rating groups and/or interrogation types.

To reiterate, a given charging request is associated with a certain service identifier if the charging request involves a communication service corresponding to the certain service identifier. A given charging request is associated with a certain rating group if the charging request involves a communication service corresponding to the certain rating group. A given charging request is associated with a certain interrogation type if the involved session state matches the certain interrogation type, e.g., a charging request to establish a session, or to continue a session, or to close a session.

Further, the term “applies” as used with respect to abatement treatments does not mean that every charging request to which an abatement treatment “applies” is discarded, or buffered. Instead, “applies” should be understood as meaning that the configuration information indicates whether or to what extent given charging requests are subject to the abatement treatment, e.g., discarding every tenth one of the subject charging requests. In any case, overload control shall be understood as applying an abatement treatment at the CTF 125 that reduces the rate, pace, or intensity of charging request signaling incoming to the OCS 120 from the CTF 125. Further, it shall be understood that the OCS 120 configures such abatement by sending configuration information to the CTF 125, for configuring one or more abatement treatments that prioritize some charging requests over others, in terms of any one or more of associated service identifiers, associated rating groups, and associated interrogation types.

In terms of functional or processing unit implementations, the processing circuitry 227 may implement an interface unit 245, shown as IU 245 in the illustration, that is operative to receive incoming charging requests. Further, the processing circuitry 227 may implement a decision unit 250, shown as DU 250 in the illustration, that is operative to select the loss algorithm or algorithms to be applied at one or more CTFs, in dependence on the load situation at the OCS 120. As such, the DU 250 can be understood as operating dynamically, based on the changing load situation at the OCS 120. As such the loss algorithm or algorithms—abatement treatments—selected by the DU as being currently appropriate for use at the CTF(s) 125 changes as a function of changing load situation.

Such changes may be indicated to the involved CTFs 125 by sending updated configuration information in one or more charging request responses sent via the IU 245. In one embodiment, or under certain circumstances, the DU 250 may choose between no abatement and abatement, in dependence on whether its load is above a threshold. In another embodiment, or under other circumstances, the DU 250 may choose or adjust the degree of abatement for one or more classes of charging requests, in dependence on the load situation at the OCS 120. In the same or other embodiments, or under the same or other circumstances, the DU 250 may choose or adjust the class or classes of charging requests subject to abatement, in dependence on the load situation at the OCS 120. Here, the “class” of a charging request is defined by any one or more of service identifier, rating group, and interrogation type.

In one approach, the OCS 120 selects an overall reduction percentage based on the load situation of the OCS 120, and configures the class or classes of charging requests to which the percentage reduction applies. Here, the load situation reflects the load on the OCS 120, i.e., the work load of the OCS 120, such as may be expressed in terms of CPU load. For example, with each incoming charging request representing a transaction to be processed by the OCS 120, the work load of the OCS may be understood as being dependent upon the number of charging requests received in a given interval—i.e., the rate of incoming charging requests. Note that “rate of incoming charging requests” refers to the number per time unit, e.g., the “pace” at which the OCS receives charging requests, and should not be confused with the word “rate” as used in terms of “rating group” in a cost or charging sense.

With the above possibilities in mind, an example OCS 120 is configured for operation in a communication network 100 and includes a processing apparatus 130 that is configured to perform overload control for the OCS 120. The processing apparatus 130 is operative as an OCF 130 within the OCS 120 and includes interface circuitry 231 configured for communicating with one or more CTFs 125 in the communication network 100, along with processing circuitry 227 that is operatively associated with the interface circuitry 231 and configured to carry out certain overload control operations.

In at least one such embodiment, the processing circuitry 227 is configured to determine configuration information dynamically as a function of load arising at the OCS 120 from ongoing reception and processing of charging requests sent from the one or more CTFs 125. Each given charging request has one or more of an associated service identifier, an associated rating group, and an associated interrogation type, and the configuration information configures one or more abatement treatments to be applied by at least one of the one or more CTFs 125, for abating the rate at which the at least one CTF 125 sends charging requests to the OCS 120. The processing apparatus 130 determines the configuration information according to a defined prioritization scheme that determines which charging requests are subject to which abatement treatment, as a function of at least one of service identifier, rating group, and interrogation type. Further, the processing circuitry 227 is configured to send the configuration information to the at least one CTF 125.

The prioritization scheme may be defined by stored data in the OCS 120, which may be provisioned or configured by the network operator, to reflect traffic priorities. For example, the prioritization scheme reflects the prioritization of some services or business partners over others, or reflects prioritization of the user experience, e.g., a preference for making charging requests associated with the establishment of communication sessions subject to abatement, while excluding from abatement those charging requests that are associated with continuing or closing established communication sessions.

In some embodiments, the processing circuitry 227 is configured to select the at least one CTF 125 from among the one or more CTFs 125, based on determining that the at least one CTF 125 supports at least one of the one or more abatement treatments. That is, the OCS 120 may receive charging requests from a multiplicity of CTFs 125, and not all of them may support the differentiated abatement treatments contemplated herein. Further, even among the CTFs 125 that do support differentiated abatement, not all them necessarily will support all treatments defined at the OCS 120. In an example embodiment or operating scenario, the processing circuitry 227 is configured to determine that the at least one CTF 125 supports at least one of the one or more abatement treatments, based on receiving feature information from the at least one CTF 125, indicating support for at least one of the one or more abatement treatments.

In the same or in further embodiments, the OCS 120 and the one or more CTFs 125 operate according to the DIAMETER protocol, wherein charging requests comprise Credit Control Requests, CCRs, and wherein the OCS 120 is configured to return a Credit Control Answer, CCA, in response to receiving a CCR. Correspondingly, the processing circuitry 227 is configured to send the configuration information in one or more CCAs sent to the at least one CTF 125. Further along these lines, the processing circuitry 227 in at least one such embodiment is configured to receive feature information from the at least one CTF 125 in one or more CCRs sent from the at least one CTF 125. The feature information received from each such CTF 125 indicates which ones of the one or more abatement treatments are supported by the CTF 125, and wherein the processing circuitry 227 is configured to determine the configuration information for each such CTF 125 in dependence on the abatement treatments supported by the CTF 125.

For example, there may be a defined set of abatement treatments. Each abatement treatment specifies, for example an amount or extent of abatement to be applied and a type of abatement to be applied, and further specifies the charging requests subject to the treatment in terms of associated service identifiers and/or associated rating groups and/or associated interrogation types. As noted, specifying subject charging requests in terms of service identifiers, rating groups, or interrogation types can be understood as specifying the “class” or classes of charging requests that are subject to the abatement treatment. Further, the abatement treatment may be specified in terms of the amount or extent of abatement, for example, as a percentage reduction ranging from 0% for no abatement, to 100% for full abatement. Still further, the type of abatement may be specified, for example, as abatement by discarding, or abatement by buffering.

In at least one embodiment, the OCS 120 has stored data, e.g., the configuration data 237, that defines an abatement treatment that defines whether or to what extent abatement is applied to given charging requests as a function of service identifiers. For example, the abatement treatment specifies at least one of: one or more service identifiers representing charging requests that are not subject to abatement, one or more service identifiers representing charging requests that are subject to abatement, and one or more service identifiers that are subject to specified levels of abatement.

In the same embodiment or in a further embodiment, the OCS 120 has stored data that defines an abatement treatment that defines whether or to what extent abatement is applied to given charging requests as a function of rating groups. For example, the abatement treatment specifies at least one of: one or more rating groups representing charging requests that are not subject to abatement, one or more rating groups representing charging requests that are subject to abatement, and one or more rating groups that are subject to specified levels of abatement.

In the same embodiment or in a further embodiment, the OCS 120 has stored data that defines an abatement treatment that defines whether or to what extent abatement is applied to given charging requests as a function of the interrogation types. For example, the abatement treatment specifies at least one of: one or more interrogation types representing charging requests that are not subject to abatement, one or more interrogation types representing charging requests that are subject to abatement, and one or more interrogation types that are subject to specified levels of abatement.

The configuration information sent by the OCS 120 to respective CTFs 125 configure any or all such abatement treatments at the CTFs 125, at least to the extent that the CTFs 125 support such configurations. Further, for dynamically determining the configuration information as a function of load arising at the OCS 120, the processing circuitry 227 of the processing apparatus 130 in the OCS 120 is, in one or more embodiments, configured to update the configuration information in dependence on current load at the OCS 120. Consequently, the involved CTFs 125 control imposition of the one or more abatement treatments dynamically, as a function of the current load at the OCS 120. That is, the OCS 120 updates the configuration information dynamically, to reflect the changing load situation at the OCS 120, and sends the updated configuration information to one or more CTFs 125, so that those one or more CTFs 125 update their abatement treatment configurations to match the current load situation at the OCS 120.

FIG. 3 illustrates a method 300 of overload control at an OCS 120, which, for example, is performed by the processing apparatus 130 illustrated in FIG. 2. The method 300 includes determining (302) configuration information dynamically as a function of load arising at the OCS (120) from ongoing reception and processing of charging requests sent from one or more CTFs 125 in the communication network 100. Each given charging request has an associated service identifier, an associated rating group, and an associated interrogation type. Correspondingly, the configuration information configures one or more abatement treatments to be applied by at least one of the one or more CTFs 125, for abating the rate at which the at least one CTF 125 sends charging requests to the OCS 120.

According to the method 300, the processing apparatus 130 determines the configuration information according to a defined prioritization scheme that determines which charging requests are subject to which abatement treatment, as a function of at least one of service identifier, rating group, and interrogation type. The method 300 further includes sending (304) the configuration information to the at least one CTF 125.

Selecting the at least one CTF 125 from among the one or more CTFs (125) is based, for example, on determining that the at least one CTF 125 supports at least one of the one or more abatement treatments. In at least one embodiment, determining that the at least one CTF 125 supports at least one of the one or more abatement treatments comprises receiving feature information from the at least one CTF 125, indicating support for at least one of the one or more abatement treatments, e.g., support for differentiated abatement as a function of service identifier, support for differentiated abatement as a function of rating group, or support for differentiated abatement as a function of interrogation type.

In an example scenario, the OCS 120 and the one or more CTFs 125 operate according to the DIAMETER protocol, wherein charging requests comprise CCRs, and wherein the OCS 120 returns a CCA, in response to receiving a CCR. Here, the method 300 may include sending the configuration information in one or more CCAs sent to the at least one CTF 125. Further, the method 300 in such a scenario may include receiving feature information from the at least one CTF 125 in one or more CCRs sent from the at least one CTF 125. The received feature information indicates which ones of the one or more abatement treatments are supported by the at least one CTF 125. Correspondingly, the method 300 further includes determining the configuration information for the at least one CTF 125 in dependence on the supported abatement treatments.

In at least one embodiment, the method 300 includes updating the configuration information in dependence on current load at the OCS 120, such that the at least one CTF 125 controls imposition of the one or more abatement treatments dynamically, as a function of the current load at the OCS 120.

Turning to CTF-related examples, in one or more embodiments a processing apparatus is operative as a CTF 125 in a communication network 100, and is configured for overload control for an OCS 120 associated with the network 100. The CTF 125 includes interface circuitry 131 that is configured for communicating with the OCS 120, and processing circuitry 127 that is operatively associated with the interface circuitry 131 and configured to carry out certain operations for overload control.

In at least one embodiment, the processing circuitry 127 is configured to receive configuration information from the OCS 120, and control abatement of the rate at which the CTF 125 sends charging requests to the OCS 120, according to the configuration information. Each given charging request is associated with one or more of a service identifier, a rating group, and an interrogation type. Correspondingly, the configuration information configures one or more abatement treatments that are applied by the CTF 125, including indicating which charging requests are subject to which abatement treatment, as a function of at least one of the associated service identifiers, the associated rating groups, and the associated interrogation types. That is, a given abatement treatment may be understood as being defined by the amount or extent of abatement to be applied, the type of abatement to be applied, and the class or classes of charging requests that are subject to the abatement treatment. As noted before, “class” may be specified in terms of any one or combination of: service identifiers, rating groups, and interrogation types.

In at least one embodiment, the processing circuitry 127 is configured to receive the configuration information in response to sending feature information to the OCS 120. The feature information indicates which abatement treatments are supported by the CTF 125, e.g., by indicating which types of charging request differentiations are supported by the CTF 125. Here, “type” of charging request differentiation refers to whether the CTF 125 supports differentiation by any or all of service identifier, rating group, and interrogation type.

The processing circuitry 127 in one or more embodiments is configured to receive the configuration information from the OCS 120 as dynamically updated configuration information, reflecting current load at the OCS 120.

In at least one embodiment, the CTF 125 and the OCS 120 operate according to the DIAMETER protocol, and the processing circuitry 127 is configured to receive the configuration information in one or more CCAs sent to the CTF 125 by the OCS 120 in response to corresponding charging requests sent from the CTF 125 to the OCS 120. In the DIAMETER protocol context, the charging requests are CCRs.

For each of the one or more abatement treatments, the configuration information specifies whether or to what extent the abatement treatment is applied to given charging requests, as a function of at least one of service identifier, rating group, and interrogation type. Thus, the processing circuitry 127 is configured to control abatement by applying the one or more abatement treatments, as specified by the configuration information.

FIG. 4 illustrates a method 400 of overload control for an OCS 120 associated with a communication network 100, where a CTF 125 in the network 100 performs the method 400. The illustrated method includes receiving (402) configuration information from the OCS 120, and controlling (404) abatement of the rate at which the CTF 125 sends charging requests to the OCS 120, according to the configuration information. Each given charging request is associated with at least one of a service identifier, a rating group, and an interrogation type, and the configuration information configures one or more abatement treatments that are applied by the CTF 125, including indicating which charging requests are subject to which abatement treatment, as a function of at least one of service identifier, rating group, and interrogation type.

The method 400 may include receiving the configuration information in response to sending feature information to the OCS 120, the feature information indicating which abatement treatments are supported by the CTF 125. Further, receiving the configuration information from the OCS 120 may include receiving dynamically updated configuration information, reflecting current load at the OCS 120.

In at least one embodiment, the CTF 125 and the OCS 120 operate according to the DIAMETER protocol, and the method 400 includes receiving the configuration information in one or more CCAs sent to the CTF 125 by the OCS 120 in response to corresponding CCRs sent from the CTF 125 to the OCS 120.

For each of the one or more abatement treatments, the configuration information received at the CTF 125 specifies whether or to what extent the abatement treatment is applied to given charging requests, as a function of at least one of service identifier, rating group, and interrogation type. Thus, controlling abatement at the CTF 125 comprises applying the one or more abatement treatments, as specified by the configuration information.

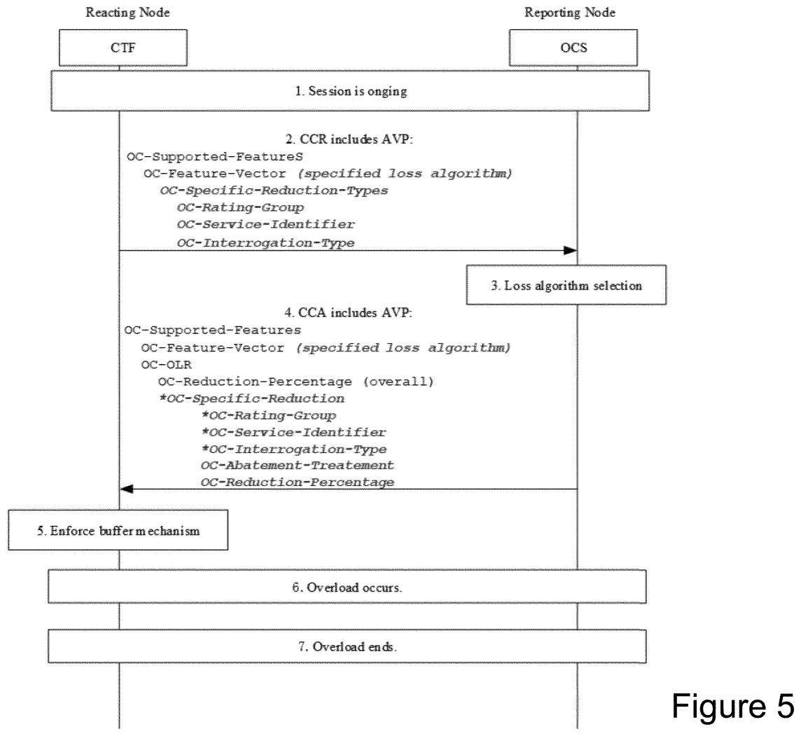

FIG. 5 illustrates an example message sequence diagram, showing signaling according to one or more embodiments. The diagram illustrates the exchange of information in the context of a charging session that is ongoing—see Step 1. Here, the ongoing charging session will be understood as involving an established, ongoing communication session. Further, the signaling diagram uses the CCR and CCA naming convention used in the DIAMETER protocol, for charging requests going from the CTF 125 to the OCS 120, and charging request responses going in return from the OCS 120 to the CTF 125.

At Step 2, the CTF 125 sends a CCR that advantageously includes feature information indicating the overload control features it supports, i.e., an indication of its support for one or more forms of the differentiated abatement as contemplated herein. For example, it may specify whether it supports differentiation by rating group, by service identifier, and/or by interrogation type. The feature information allows the OCS 120 to determine what level of support the CTF 125 has for overload control according to its defined prioritization scheme.

As seen in the signaling flow, the feature information may be included as one or more Attribute-Value Pairs or AVPs. Of further note, the diagram abbreviates “overload control” as “OC”. Thus, the AVP “OC-Rating-Group”, for example, indicates whether the CTF 125 supports differentiation between charging requests as a function of their associated rating groups, for the application of an abatement treatment. Similar definitions hold for the “OC-Service-Identifier” and “OC-Interrogation-Type” AVPs.

In at least one embodiment, the CTF 125 has a default loss algorithm—abatement treatment—to use, should no configuration information be provided to it from the OCS 120. In cases where the OCS 120 supports only one abatement treatment, the exchange of feature and configuration information may be simplified, but the OCS 120 may nonetheless dynamically control and configure imposition of the abatement treatment at the CTF 125, in dependence on the load situation at the OCS 120.

In Step 3, the OCS 120 selects or otherwise configures a specific loss algorithm for overload control usage. The default OC-Reduction-Percentage AVP is selected by the OCS 120 based on the current load situation at the OCS 120, e.g. the CPU load. The OCS 120 then sets or configures the AVPs associated with differentiated treatment of charging requests, e.g., it specifies which charging requests are subject to abatement treatment—i.e., subject to abatement according to the specified OC-Reduction-Percentage—by specifying at least one of the following: one or more rating groups, one or more service identifiers, and one or more interrogation types. These AVPs thus define the charging requests that are subject to the OC-Reduction-Percentage, in terms of any one or more of their associated rating groups, service identifiers, and interrogation types.

The OC-Specific-Reduction will be repeated for each separate reduction percentage specified, and within this the types of charging requests that need special treatment are repeated. The configuration information could also include a separate treatment for the request type, e.g., it may specify the type of abatement as request diversion, request buffering, or request discarding.

The OCS 120 responds in Step 4 by sending a CCA that includes the configured AVPs. In an example scenario, the returned CCA indicates one or more of the following:

OC-Specific-Reduction

OC-Rating-Group: 1000 (indicating Social Media)

OC-Reduction-Percentage: 90%

OC-Abatement-Treatment: Discard

OC-Specific-Reduction

OC-Service-Identifier: 2001 (indicating NETFLIX)

OC-Reduction-Percentage: 5%

OC-Abatement-Treatment: Buffer

The above configuration information indicates to the CTF 125 that there is a need to decrease the Social Media related requests by 90%, based on discarding. The configuration information further indicates that the CTF 125 should decrease charging requests associated with NETFLIX by 5%, and that it should use buffering to achieve that reduction.

In step 5, the CTF 125 configures the specified abatement treatments and it may apply them immediately, e.g., in embodiments where the CTF 125 imposes or abstains from abatement in direct dependence on the latest received configuration information. Alternatively, the CTF 125 configures the specified abatement treatments but does not apply them until triggered, e.g., by the OCS 120 indicating an overload situation—See Step 6. In such embodiments, the CTF 125 would begin applying the configured abatement treatments until the overload situation ends at the OCS 120—see Step 7.

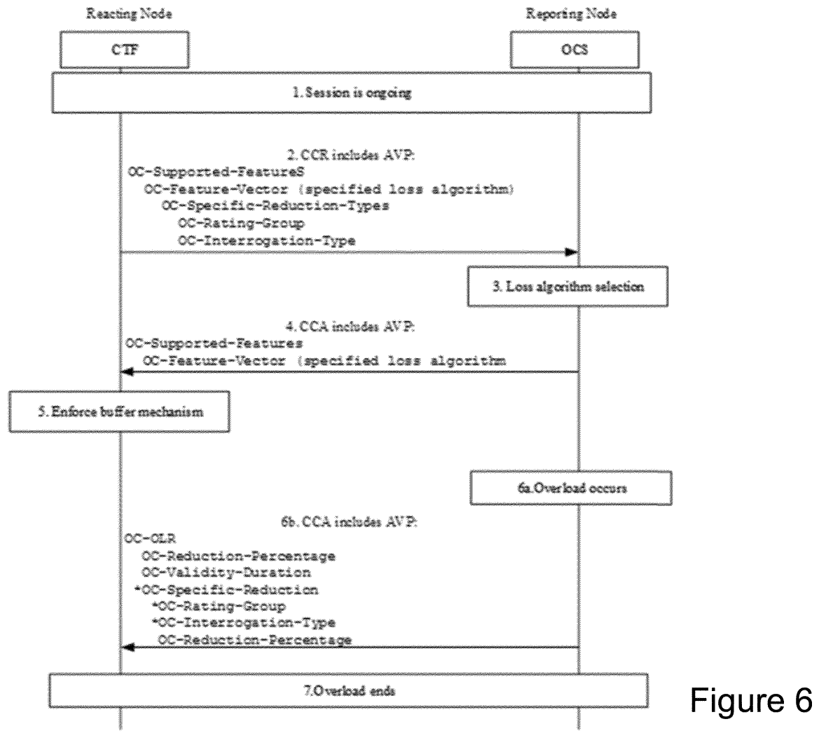

FIG. 6 illustrates another example signaling flow diagram, which is similar to that detailed in FIG. 5. Step 1 denotes an ongoing charging session between the CTF 125 and the OCS 120. Step 2 involves the CTF 125 sending a CCR to the OCS 120, where the CCR includes AVPs indicating the overload control features supported by the CTF 125. Specifically, the CCR indicates feature information identifying the particular support provided by the CTF 125 for differentiated abatement as taught herein.

In Step 3, the OCS 120 uses the received feature information to select and configure one or more loss algorithms—abatement treatments—for the CTF 125. The OCS 120 returns corresponding configuration information to the CTF 125 in a CCA that is responsive to the CCR received by the OCS 120 in Step 2.

In Step 5, the CTF 125 enforces a buffer mechanism reflecting the configured abatement treatment or treatments, as specified by the configuration information returned to the CTF 125 in the CCA. Note, Step 5 may be understood as the CTF 125 implementing the appropriate abatement treatment configuration, but does not necessarily mean that the CTF 125 imposes the configured abatement treatment. For example, imposition of the configured abatement treatment may be triggered responsive to the CTF 125 receiving further information.

In the specific example illustrated, overload occurs at the OCS 120 at Step 6a, and, at Step 6b, the OCS 120 indicates the overload to the CTF 125 by returning a CCA that includes AVPs setting specific reduction percentages for abatement, specific durations for imposing the abatement, and specific service identifiers, rating groups, or interrogation types for which the specified abatements apply. Upon receiving these AVPs, the CTF 125 imposes—activates the specified abatement treatments on further CCRs. The specified abatement treatments are imposed according to the specified durations, or upon the CTF 125 receiving updated configuration information indicating an end to the overload situation at the OCS 120—see Step 7.

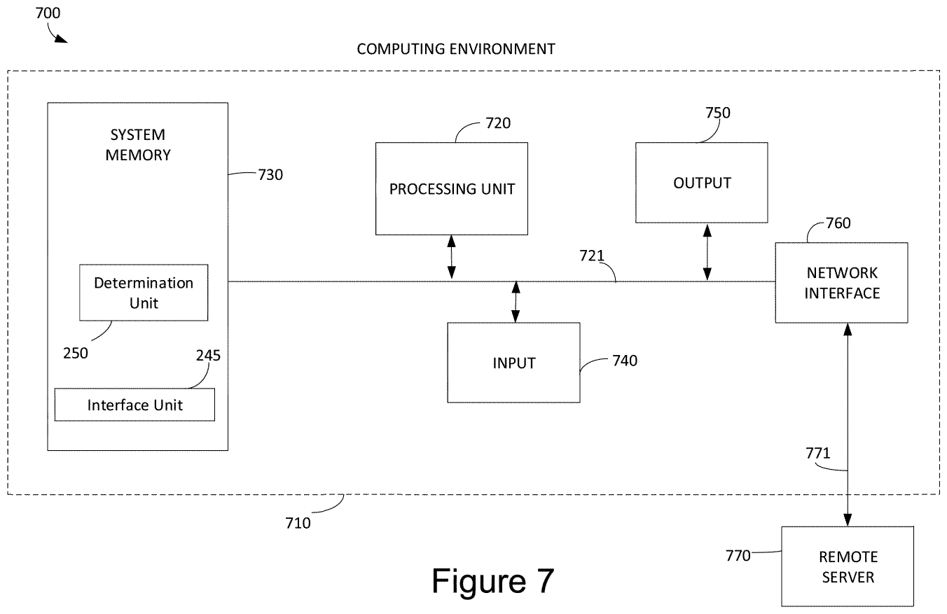

FIG. 7 is a block diagram of another example embodiment of an OCS 120 for overload control as contemplated herein. In particular, FIG. 7 illustrates an example computing system environment 700, such as may be used for implementation of the requisite OCS functionality, or supporting CTF functionality.

However, it should be understood that the computing system environment 700 is only one example of a suitable computing environment and is not intended to suggest any limitation as to the scope of use or functionality of the claimed subject matter. Further, the computing system environment 700 is not intended to suggest any dependency or requirement relating to the claimed subject matter and any one or combination of components illustrated in the example environment 700.

An example of a device or system for implementing the previously described OCS 120, the computing environment 700 includes a general-purpose computing device in the form of a computer 710, wherein the computer 710 is specially adapted to carry out overload control processing as taught herein. In the illustrated example, the computer 710 includes a CPU 720 or other processing unit, system memory 730, and a system bus 721 that couples various system components, including the system memory, to the processing unit 720. The system bus 721 can be any of several types of bus structures including a memory bus or memory controller, a peripheral bus, and a local bus using any of a variety of bus architectures.

The computer 710 includes, for example, transitory computer readable medium for program execution and associated “live” data storage, and further includes one or more types of non-transitory computer readable media for, e.g., non-volatile storage of computer program instructions, the execution of which specially adapts the computer 710, and for the storage of configuration information. By way of example, and not limitation, computer readable media can comprise computer storage media and communication media.

Computer storage media includes volatile and nonvolatile as well as removable and non-removable media implemented in any method or technology for storage of information such as computer readable instructions, data structures, program modules or other data. Examples of computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 710.

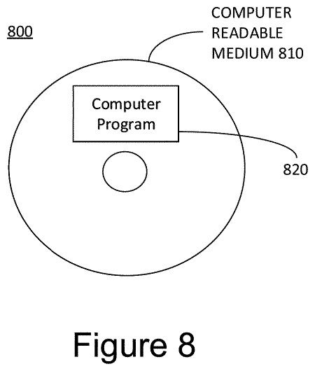

FIG. 8, for example, illustrates computer readable media in the form of a computer program product 810 including a computer program 820, together comprising a computer program product 800. In one embodiment, the computer program 820 includes program instructions that configure the computer 710 to operate as an OCF 130 as described herein, for overload control based on differentiated abatement. In another embodiment, the computer program includes program instructions that configure the computer 710 to operate as a CTF 125, for overload control based on differentiated abatement.

Included communication media in the computer 710 can embody computer readable instructions, data structures, program modules or other data in a modulated data signal such as a carrier wave or other transport mechanism and can include any suitable information delivery media.

As noted, the system memory 730 can include computer storage media in the form of volatile and/or nonvolatile memory such as read only memory (ROM) and/or random-access memory (RAM). A basic input/output system (BIOS), containing the basic routines that help to transfer information between elements within computer 710, such as during start-up, can be stored in the system memory 730. The system memory 730 can also contain data and/or program modules for operation by processing unit 720. By way of non-limiting example, the system memory 730 can also include an operating system, application programs, other program modules, and program data, at least during live operation.

In at least one such example where the computer 710 is configured for OCS operation, the system memory 730 provides for the instantiation of a run-time environment or working space used by the processing unit 720 for implementation of the IU 245 and DU 250 described earlier herein. Broadly, the system memory 730 may include a software module loaded in the memory and processable by the processing unit 720, or other circuitry which cause an online charging system to perform overload control based on differentiated abatement, as described herein.

In particular, the system memory 730 may include a software module loaded in the memory and processable by the processing unit or other circuitry, which cause an online system to perform the steps or processes of the method 300, illustrated in FIG. 3.

The computer 710 can also include other removable/non-removable and volatile/nonvolatile computer storage media. For example, the computer 710 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 721 through a non-removable memory interface such as an interface, and a magnetic disk drive or optical disk drive can be connected to the system bus 721 by a removable memory interface, such as an interface.

In at least one embodiment, a user can enter commands and information into the computer 710 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 720 through user input 740 and associated interface(s) that are coupled to the system bus 721, but can be connected by other interface and bus structures, such as a parallel port, game port or a universal serial bus (USB).

A graphics subsystem can also be connected to the system bus 721. In addition, a monitor or other type of display device can be connected to the system bus 721 through an interface, such as output interface 750, which can in turn communicate with video memory. In addition to a monitor, computers can also include other peripheral output devices, such as speakers and/or printing devices, which can also be connected through the output interface 750.

The computer 710 in one or more embodiments is configured to operate in a networked or distributed environment wherein it is communicatively coupled to one or more other remote computers, such as remote server 770, which can in turn have media or other operational capabilities different from the computer 710. The remote server 770 may be a personal computer, a server, a router, a network PC, a peer device or other common network node, and/or any other remote media consumption or transmission device, and can include any or all of the elements described above relative to the computer 710. The logical connections depicted in FIG. 7 include a network 771, such as a local area network (LAN), a wide area network (WAN), or another type of network or bus.

When used in a LAN networking environment, the network 771 is a LAN and the computer 710 is connected to the LAN through a network interface or adapter 760. When used in a WAN networking environment, the computer 710 can include a communications component, such as a modem, or other means for establishing communications over a WAN, such as the Internet. A communications component, such as a modem, which can be internal or external, can be connected to the system bus 721 through the user input interface at input 740 and/or other appropriate mechanism.

In a networked environment, program modules depicted relative to the computer 710, or portions thereof, can be stored in a remote memory storage device. It should be noted that the network connections shown and described are exemplary and other means of establishing a communications link between the computers can be used.

As noted, FIG. 8 shows a computer program product 800, comprising a non-transitory computer readable medium 810 and a computer program 820 stored on the computer readable medium 810. The computer program 820 comprises, for example, computer readable code means, which when run in a computer configured as an online charging system for a communication network, configure the computer to perform the steps of associating one or more charging modifier actions with a user account, each charging modifier actions having an action start time and defining a charging modifier parameter and receiving a service authorization request indicating a request for service reservation from a charging client. The computer readable code means also causes the computer to perform the steps for overload control of charging signaling as described herein, e.g., in the context of any one or more of FIGS. 3-6.

Additionally, it should be noted that as used in this application, terms such as “component,” “display,” “interface,” and other similar terms are intended to refer to a computing device, either hardware, a combination of hardware and software, software, or software in execution as applied to a computing device. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and sub-combination of these embodiments. Accordingly, the present specification, including the drawings, shall be construed to constitute a complete written description of various exemplary combinations and sub-combinations of embodiments and of the manner and process of making and using them, and shall support claims to any such combination or sub-combination.

Many variations and modifications can be made to the embodiments without substantially departing from the principles of the present solution. All such variations and modifications are intended to be included herein within the scope of the present solution.

1-34. (canceled)

35. A method of overload control in an Online Charging System, OCS, associated with a communication network, the method performed by a processing apparatus in the OCS and comprising:
determining configuration information dynamically as a function of load arising at the OCS from ongoing reception and processing of charging requests sent from one or more Charging Trigger Functions, CTFs, in the communication network, each given charging request being associated with at least one of a service identifier, a rating group, and an interrogation type, the configuration information configuring one or more abatement treatments to be applied by at least one of the one or more CTFs, for abating the rate at which the at least one CTF sends charging requests to the OCS, and being determined by the processing apparatus according to a defined prioritization scheme that determines which charging requests are subject to which abatement treatment, as a function of at least one of service identifier, rating group, and interrogation type; and
sending the configuration information to the at least one CTF.

36. The method of claim 35, further comprising selecting the at least one CTF from among the one or more CTFs, based on determining that the at least one CTF supports at least one of the one or more abatement treatments.

37. The method of claim 36, wherein determining that the at least one CTF supports at least one of the one or more abatement treatments comprises receiving feature information from the at least one CTF, indicating support for at least one of the one or more abatement treatments.

38. The method of claim 35, wherein the OCS and the one or more CTFs operate according to the DIAMETER protocol, wherein charging requests comprise Credit Control Requests, CCRs, and wherein the OCS returns a Credit Control Answer, CCA, in response to receiving a CCR, and wherein the method includes sending the configuration information in one or more CCAs sent to the at least one CTF.

39. The method of claim 38, further comprising receiving feature information from the at least one CTF in one or more CCRs sent from the at least one CTF, the feature information indicating which ones of the one or more abatement treatments are supported by the at least one CTF, and wherein the method further comprises determining the configuration information for the at least one CTF in dependence on the supported abatement treatments.

40. The method of claim 35, wherein the one or more abatement treatments comprise an abatement treatment that defines whether or to what extent abatement is applied to given charging requests as a function of service identifier.

41. The method of claim 40, wherein the abatement treatment that defines whether or to what extent abatement is applied to given charging requests as a function of service identifier specifies at least one of: one or more service identifiers representing charging requests that are not subject to abatement, one or more service identifiers representing charging requests that are subject to abatement, and one or more service identifiers that are subject to specified levels of abatement.

42. The method of claim 35, wherein the one or more abatement treatments comprise an abatement treatment that defines whether or to what extent abatement is applied to given charging requests as a function of rating group.

43. The method of claim 42, wherein the abatement treatment that defines whether or to what extent abatement is applied to given charging requests as a function of rating group specifies at least one of: one or more rating groups representing charging requests that are not subject to abatement, one or more rating groups representing charging requests that are subject to abatement, and one or more rating groups that are subject to specified levels of abatement.

44. The method of claim 35, wherein the one or more abatement treatments comprise an abatement treatment that defines whether or to what extent abatement is applied to given charging requests as a function of interrogation type.

45. The method of claim 44, wherein the abatement treatment that defines whether or to what extent abatement is applied to given charging requests as a function of interrogation type specifies at least one of: one or more interrogation types representing charging requests that are not subject to abatement, one or more interrogation types representing charging requests that are subject to abatement, and one or more interrogation types that are subject to specified levels of abatement.

46. The method of claim 35, wherein determining the configuration information dynamically as a function of load arising at the OCS from ongoing reception and processing of charging requests sent from the one or more CTFs in the communication network, comprises updating the configuration information in dependence on current load at the OCS, such that the at least one CTF controls imposition of the one or more abatement treatments dynamically, as a function of the current load at the OCS.

47. A processing apparatus configured to perform overload control for an Online Charging System, OCS, associated with a communication network, the processing apparatus operative as an Online Charging Function, OCF, in the OCS and comprising:
interface circuitry configured for communicating with one or more Charging Trigger Functions, CTFs, in the communication network; and
processing circuitry operatively associated with the interface circuitry and configured to:
determine configuration information dynamically as a function of load arising at the OCS from ongoing reception and processing of charging requests sent from the one or more CTFs, each given charging request being associated with one or more of a service identifier, a rating group, and an interrogation type, the configuration information configuring one or more abatement treatments to be applied by at least one of the one or more CTFs, for abating the rate at which the at least one CTF sends charging requests to the OCS, and being determined by the processing apparatus according to a defined prioritization scheme that determines which charging requests are subject to which abatement treatment, as a function of at least one of service identifier, rating group, and interrogation type; and
send the configuration information to the at least one CTF.

48. The processing apparatus of claim 47, wherein the processing circuitry is configured to select the at least one CTF from among the one or more CTFs, based on determining that the at least one CTF supports at least one of the one or more abatement treatments.

49. The processing apparatus of claim 48, wherein the processing circuitry is configured to determine that the at least one CTF supports at least one of the one or more abatement treatments, based on receiving feature information from the at least one CTF, indicating support for at least one of the one or more abatement treatments.

50. The processing apparatus of claim 47, wherein the OCS and the one or more CTFs operate according to the DIAMETER protocol, wherein charging requests comprise Credit Control Requests, CCRs, and wherein the OCS is configured to return a Credit Control Answer, CCA, in response to receiving a CCR, and wherein the processing circuitry is configured to send the configuration information in one or more CCAs sent to the at least one CTF.

51. The processing apparatus of claim 50, wherein the processing circuitry is configured to receive feature information from the at least one CTF in one or more CCRs sent from the at least one CTF, the feature information indicating which ones of the one or more abatement treatments are supported by the at least one CTF, and wherein the processing circuitry is configured to determine the configuration information for the at least one CTF in dependence on the supported abatement treatments.

52. The processing apparatus of claim 47, wherein the one or more abatement treatments comprise an abatement treatment that defines whether or to what extent abatement is applied to given charging requests as a function of service identifier.

53. The processing apparatus of claim 52, wherein the abatement treatment that defines whether or to what extent abatement is applied to given charging requests as a function of service identifier specifies at least one of: one or more service identifiers representing charging requests that are not subject to abatement, one or more service identifiers representing charging requests that are subject to abatement, and one or more service identifiers that are subject to specified levels of abatement.

54. The processing apparatus of claim 47, wherein the one or more abatement treatments comprise an abatement treatment that defines whether or to what extent abatement is applied to given charging requests as a function of rating group.

55. The processing apparatus of claim 54, wherein the abatement treatment that defines whether or to what extent abatement is applied to given charging requests as a function of rating group specifies at least one of: one or more rating groups representing charging requests that are not subject to abatement, one or more rating groups representing charging requests that are subject to abatement, and one or more rating groups that are subject to specified levels of abatement.

56. The processing apparatus of claim 47, wherein the one or more abatement treatments comprise an abatement treatment that defines whether or to what extent abatement is applied to given charging requests as a function of interrogation type.

57. The processing apparatus of claim 56, wherein the abatement treatment that defines whether or to what extent abatement is applied to given charging requests as a function of interrogation type specifies at least one of: one or more interrogation types representing charging requests that are not subject to abatement, one or more interrogation types representing charging requests that are subject to abatement, and one or more interrogation types that are subject to specified levels of abatement.

58. The processing apparatus of claim 47, wherein, to dynamically determine the configuration information as a function of load arising at the OCS, the processing circuitry is configured to update the configuration information in dependence on current load at the OCS, such that the at least one CTF controls imposition of the one or more abatement treatments dynamically, as a function of the current load at the OCS.

59. A method of overload control for an Online Charging System, OCS, associated with a communication network, the method performed by a Charging Trigger Function, CTF, in the communication network and comprising:
receiving configuration information from the OCS; and
controlling abatement of the rate at which the CTF sends charging requests to the OCS, according to the configuration information;
wherein each given charging request is associated with at least one of a service identifier, a rating group, and an interrogation type; and
wherein the configuration information configures one or more abatement treatments that are applied by the CTF, including indicating which charging requests are subject to which abatement treatment, as a function of at least one of service identifier, rating group, and interrogation type.

60. The method of claim 59, further comprising receiving the configuration information in response to sending feature information to the OCS, the feature information indicating which abatement treatments are supported by the CTF.

61. The method of claim 59, wherein receiving the configuration information from the OCS comprises receiving dynamically updated configuration information, reflecting current load at the OCS.

62. The method of claim 59, wherein the CTF and the OCS operate according to the DIAMETER protocol, and wherein receiving the configuration information comprises receiving the configuration information in one or more Credit Control Answers, CCAs, sent to the CTF by the OCS in response to corresponding charging requests sent from the CTF to the OCS, the charging requests comprising Credit Control Requests, CCRs.

63. The method of claim 59, wherein, for each of the one or more abatement treatments, the configuration information specifies whether or to what extent the abatement treatment is applied to given charging requests, as a function of at least one of service identifier, rating group, and interrogation type, and wherein controlling abatement comprises applying the one or more abatement treatments, as specified by the configuration information.

64. A processing apparatus configured for overload control for an Online Charging System, OCS, associated with a communication network, the processing apparatus operative as a Charging Trigger Function, CTF, in the communication network and comprising:
interface circuitry configured for communicating with the OCS; and
processing circuitry operatively associated with the interface circuitry and configured to:
receive configuration information from the OCS; and
control abatement of the rate at which the CTF sends charging requests to the OCS, according to the configuration information;
wherein each given charging request is associated with at least one of a service identifier, a rating group, and an interrogation type; and
wherein the configuration information configures one or more abatement treatments that are applied by the CTF, including indicating which charging requests are subject to which abatement treatment, as a function of at least one of service identifier, rating group, and interrogation type.

65. The processing apparatus of claim 64, wherein the processing circuitry is configured to receive the configuration information in response to sending feature information to the OCS, the feature information indicating which abatement treatments are supported by the CTF.

66. The processing apparatus of claim 64, wherein the processing circuitry is configured to receive the configuration information from the OCS as dynamically updated configuration information, reflecting current load at the OCS.

67. The processing apparatus of claim 64, wherein the CTF and the OCS operate according to the DIAMETER protocol, and wherein the processing circuitry is configured to receive the configuration information in one or more Credit Control Answers, CCAs, sent to the CTF by the OCS in response to corresponding charging requests sent from the CTF to the OCS, the charging requests comprising Credit Control Requests, CCRs.

68. The processing apparatus of claim 64, wherein, for each of the one or more abatement treatments, the configuration information specifies whether or to what extent the abatement treatment is applied to given charging requests, as a function of at least one of service identifier, rating group, and interrogation type, and wherein the processing circuitry is configured to control abatement by applying the one or more abatement treatments, as specified by the configuration information.
